(19) United States
(12) Patent Application Publication
(10) Pub. No.: US 2026/0051416 A1
(43) Pub. Date: Feb. 19, 2026

(54) A MODULAR CONSTRUCTION BLOCK AND METHOD

(71) Applicant: UNITED KINGDOM ATOMIC ENERGY AUTHORITY, Abingdon Oxfordshire (GB)

(72) Inventors: Jack Astbury, Oxford Oxfordshire (GB); Juan Diego Iberico Leonardo, Madrid (ES); Teresa Ancochea Nodal, Barcelona (ES); Frank Schoofs, Abingdon Oxfordshire (GB)

(73) Assignee: UNITED KINGDOM ATOMIC ENERGY AUTHORITY, Abingdon Oxfordshire (GB)

(21) Appl. No.: 19/101,919

(22) PCT Filed: Jul. 26, 2023
(86) PCT No.: PCT/EP2023/070759

§ 371 Date: Feb. 7, 2025

(30) Foreign Application Priority Data
Aug. 8, 2022 (EP) 22382769.2

(51) Int. Cl. G21F 3/04; G21C 11/02; G21F 1/04

(52) U.S. Cl. CPC G21F 3/04; G21C 11/028; G21F 1/045

(57) ABSTRACT

A modular nuclear shield wall construction block /1, 40 )comprising a framework (30) formed from a basalt fibre reinforced polymer composite and concrete interspersed within the framework, wherein the block is configured to interlock with a corresponding block in one or more dimensions. A method (500) of forming a modular construction block (1, 40); and a method (600) of forming a modular structure are also disclosed.

### TECHNICAL FIELD

The present disclosure relates to a modular construction block and method. It is particularly, although not exclusively, concerned with a modular construction block comprising a basalt fibre reinforced polymer composite and concrete, the block being stackable in three dimensions.

### BACKGROUND

In construction, it is desirable for structures to be built in a cost effective and time efficient manner, whilst fulfilling construction requirements. In specialised fields of construction, there may exist additional construction requirements.

In the field of biological shields for nuclear reactors (“bio-shields”), a bio-shield may be required during service to absorb radiation emanating from a nuclear reactor, whilst fulfilling specialised fire and physical shock requirements. After service, during decommissioning of a nuclear facility, it may be desirable to reduce any dismantling requirements, for example by reducing (e.g., eliminating) the quantity of any nuclear waste resulting from components of the bio-shield.

### STATEMENTS OF INVENTION

According to an aspect of the present disclosure, there is provided a modular construction block. The modular construction block may comprise a fibre reinforced polymer composite (e.g., a basalt fibre reinforced polymer composite) and/or concrete. The block may be stackable (e.g., capable of interlocking or mating with other blocks) in the x-direction (e.g., wall length direction), the y-direction (e.g., wall depth or thickness dimension) and/or the z-direction (e.g., wall height direction) (e.g., stackable in any one, two or three of the x-, y- and z-directions). The block may be stackable along three directions. The block may comprise protrusions and recesses (e.g., tongues and grooves) on faces perpendicular to the x-, y- and/or z-directions configured to interact with corresponding protrusions and recesses on opposing faces of adjacent blocks in order to permit interlocking between stacked modules in the x-, y-and/or z-directions. This aspect may be used in conjunction with and/or form part of any of the following aspects.

According to another aspect of the present disclosure, there is provided a modular construction block for a nuclear shield wall (e.g., a modular nuclear shield wall construction block), the block comprising a fibre reinforced polymer composite. The block may comprise a framework formed from the fibre reinforced polymer composite. The fibre reinforced polymer composite may be a basalt fibre reinforced polymer composite. The block may comprise concrete, e.g. interspersed within the framework. The block may be configured to interlock with a corresponding block (e.g., a second and/or identical block) in one or more dimensions. The block may be stackable (e.g., capable of interlocking or mating with other blocks so as to increase a dimension of a resulting structure). The block may be stackable in the y- or depth-dimension (e.g., interlocking along faces substantially perpendicular to the y- or depth-dimension).

The block may comprise a fibre reinforced polymer composite framework. The framework may define the block (e.g., its external dimensions and/or geometry). The framework may be contained (e.g. completely contained) within the block. The framework may not extend beyond the block.

The framework may define an internal volume. The framework may define an array of cells (e.g., cells internal to the external dimensions of the framework). The array may be an array of at least 2×2 cells, such as at least 5×3 cells, such as at least 6×4 cells, in the x-y plane. Each cell may have an internal volume. Concrete may be provided within a plurality of the cells such that the concrete is interspersed within the framework (e.g., concrete may be provided between different parts of the internal framework). The framework may comprise a corrugated sheet sandwiched between two further sheets (e.g., sandwiches between two uncorrugated sheets, such as substantially planar or arcuate sheets).

Each cell may comprise a uniform cross section cross section in the x-y plane at any location along the z-axis. The cells or each cell may extend substantially uniformly along the z-direction. Each cell may comprise (e.g., consist of) a substantially trapezoidal cross section in the x-y plane. The cells may be tessellated (e.g., in the x-y plane). The cells may be provided immediately adjacent one another, without interstitial space, such that the boundaries of adjacent cells may be contiguous. The framework may comprise a trapezoidal prismatic honeycomb-type structure.

The block may be linear. The block may be arcuate or curved (e.g., perpendicular to the z-direction). The block may be configured to stack in the x- or circumferential-direction with other blocks to form a curved or complete, circular structure. The block may be configured to stack with other blocks in the y- or radial-direction to increase a depth dimension of the structure. Each cell may comprise a substantially trapezoidal cross section in the x-y plane, having two concentric arcuate sides and two parallel sides. With increasing distance from the centre (e.g. within a block and between blocks), the length of the concentric arcuate sides may increase.

At least one pair of adjacent cells within a block may comprise an opening configured to permit communication between the internal volumes of the at least one pair of adjacent cells.

The block may be stackable in the x/length- and/or z/height-dimensions (e.g., configured to interlock or mate with another block so as to increase the dimension of a resulting structure along the x- and/or z-directions respectively). The block may comprise protrusions and/or recesses in faces perpendicular to the x-, y- and/or z-directions (e.g., in faces perpendicular to any one, two or three of the x-, y- and z-directions). The protrusions may be configured to be received in recesses provided in a corresponding face of an adjacent block. The recesses may be configured to receive protrusions provided in a corresponding face of an adjacent block. When stacked, one block may thereby overlap with (e.g., coincide with) an adjacent block along the stacking dimension.

The block may be stackable in the x- and/or y-dimensions by means of a tongue and groove arrangement provided on faces perpendicular to the x- and/or y-directions respectively. The block may comprise a corner piece. The block may be configured to mate with a block extending substantially perpendicularly thereto. The block may comprise a 45-degree face configured to mate with a corresponding 45 degree face of a further block so as to form a corner of a wall.

A proportion of cells may be offset along the z-axis such that they may protrude from a face of the block being perpendicular to the z-direction. The block may comprise a corresponding array of recesses on an opposing face perpendicular to the z-direction, such that the block may be stackable along the z-direction.

The fibre may comprise basalt fibre. The composite may comprise approximately 30 vol. % basalt fibre. The polymer may comprise epoxy. The polymer may comprise a sand or aggregate coating.

The block may comprise concrete. The concrete may be provided in the internal volume of the cells. The concrete may be graded between cells. A proportion of cells (e.g., at least one cell) may not comprise concrete. The polymer may be cured prior to the pouring of concrete, such that the concrete may not infiltrate the composite and/or the basalt fibre may be provided peripherally to each concrete component. The composite may be self-supporting (e.g., by curing the polymer prior to the pouring of concrete).

The x-direction may correspond to the length or circumferential dimension of the block and/or the resulting structure. The y-direction may correspond to the depth, thickness or radial dimension of the block and/or the resulting structure. For example, the y-direction may be parallel with a shortest dimension of the block. The z-direction may correspond to the height direction of the block and/or the resulting structure (e.g., opposite to the direction of gravity).

Each block may be airtight between opposing faces. Stacked blocks may comprise an airtight connection or seal therebetween, which may resist pressure waves. The framework may comprise a lifting feature, e.g., a female connector configured to receive a male connector in order to permit manoeuvring of the block during assembly of the modular structure.

According to another aspect of the present disclosure, there is provided a structure comprising a plurality of modular construction blocks (e.g., a plurality of identical or corresponding modular construction blocks) according to any of the previous aspects. The structure may comprise stacked or interlocked blocks (e.g., along the x-, y- and/or z-directions). The structure may comprise a nuclear shield wall or bio-shield. The modular blocks may comprise uniform geometry and dimensions (e.g., in each of the x-, y- and z-directions).

According to another aspect of the present disclosure there is provided a method of forming a modular block. The method may comprise forming a fibre framework (e.g., a basalt fibre framework) (e.g., by pultrusion along the z-direction). The fibre framework may comprise a trapezoidal prismatic honeycomb-type structure.

The method may comprise impregnating the fibre framework with polymer (e.g., epoxy adhesive) so as to form the fibre framework (e.g., basalt fibre polymer composite framework). The method may comprise applying aggregates (e.g., sand) to the internal surfaces of the cells (e.g., so as to adhere to the epoxy).

The method may comprise curing the polymer (e.g., epoxy resin). The method may comprise subsequently pouring the concrete, e.g., into the internal volumes of the cells. The concrete may then be permitted to harden.

According to another aspect of the present disclosure there is provided a method of forming a modular structure (e.g., a nuclear shield wall or bio-shield), the method comprising stacking a first modular construction block and a second modular construction block. The first and second blocks may be stacked in the x/length, y/depth, and/or z/height dimension (e.g., any one, two or three of the x/length, y/depth and z/height dimensions). The method may comprise stacking a further block in the x-, y- and/or z-dimension. The modular structure may be formed after solidification of concrete.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF DRAWINGS

For a better understanding of the present invention, and to show more clearly how it may be carried into effect, reference will now be made, by way of example, to the accompanying drawings, in which:

FIG. 1 is a perspective view of a modular construction block according to the present disclosure;

FIG. 2 is a cross sectional view in the x-y plane of a modular construction block according to the present disclosure;

FIG. 3 is a perspective view of an example composition of the modular construction block of FIGS. 1 and 2;

FIG. 4 is a cross sectional view in the x-y plane of a curved modular construction block according to the present disclosure;

FIG. 5 is a flowchart of an example method of forming a modular construction block; and

FIG. 6 is a flowchart of an example method of forming a modular structure.

Like reference numerals will be used to refer to like features.

### DETAILED DESCRIPTION

### Linear Block

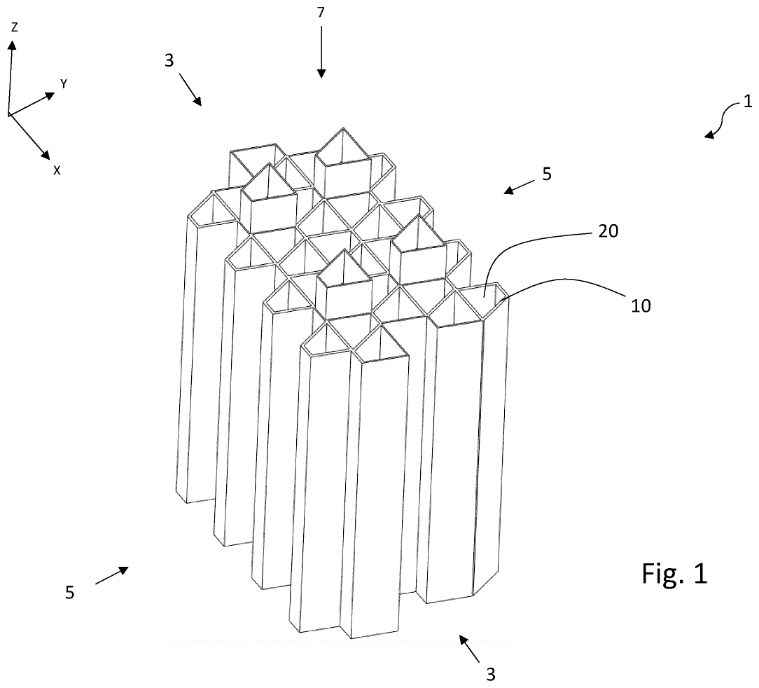

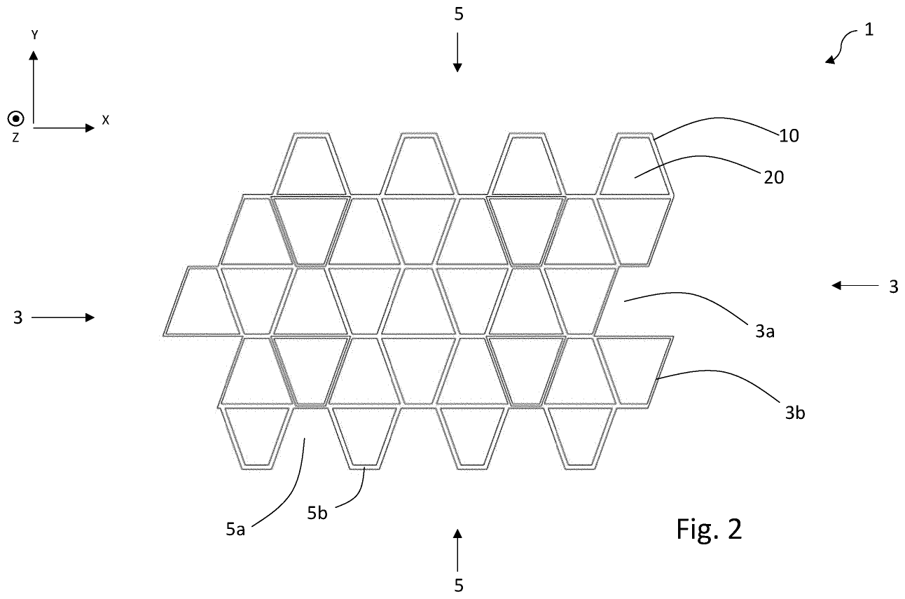

With reference to FIGS. 1 and 2, a modular construction block 1 comprises an array of trapezoidal prismatic cells 10 each having an internal trapezoidal prismatic volume 20.

The trapezoidal cells 10 are tessellated in the x-y plane. Along the x-direction, the short parallel side of one cell 10 is provided adjacent and collinear with the long parallel side of an adjacent cell 10. Along the y-direction, the long parallel side of one cell 10 is provided back-to-back with the long parallel side of an adjacent cell 10, and the short parallel side of one cell 10 is provided back-to-back with the short parallel side 10 of an adjacent cell 10.

In other words, in the x-y plane, adjacent cells 10 along each of the x- and y-directions are provided at 180 degrees to one another. The cells 10 are thereby tessellated such that one cell is provided immediately adjacent another cell 10 without an interstitial space therebetween. The boundary of one cell 10 may thereby be contiguous with the boundary of an adjacent cell 10.

Each cell 10 extends uniformly along the z-direction, such that the trapezoidal geometry in the x-y plane extends along the z-direction and a trapezoidal prismatic internal volume 20 is formed. The block 1 thereby comprises a honeycomb-type structure when viewed along the z-direction, as shown in FIG. 2.

At different locations along the z-direction, the block 1 may comprise a generally uniform cross section in the x-y plane, regardless of the location in the z-direction of the cross section. For example, the block 1 may comprise a uniform cross section in the x-y plane throughout the central majority of the z-dimension of the block 1. Towards the ends of the block 1 in the z-dimension, the block 1 may comprise a cross section in the x-y plane which differs from the central majority (e.g., comprising protruding cells and recesses), as will be described later.

The aggregate structure formed by the cells 10 is termed a framework 30 which defines an array of internal volumes 20 separated by the boundaries of the cells 10. The constitution of the framework 30 will be described later.

### Stackable in X- and Y-Dimensions

The block 1 comprises four faces parallel with and extending along the z-direction; two faces 3 substantially perpendicular to the x-direction and two faces 5 substantially perpendicular to the y-direction.

On the faces 5, every other cell 10 is omitted, such that the faces 5 comprise a series of trapezoidal grooves 5a spaced apart by trapezoidal tongues 5b in the form of cells 10. In particular, the trapezoidal tongues 5b comprise the cells 10 having their short parallel side facing outward, rather than their long parallel side. Each groove 5a may thereby be defined by two angled sides and one short parallel side of three different cells 10. In this manner, the trapezoidal grooves 5a have their long parallel side outermost such that they are configured to receive a corresponding tongue 5b of an adjacent block 1 during assembly of a plurality of modular construction blocks 1. In effect, the face 5 forms a tongue and groove face which is configured to interact with corresponding a tongue and groove face on a corresponding face 5 of an adjacent block 1 so as to stack two blocks 1 in the y-dimension.

Similarly, on the faces 3, every other cell 10 is omitted, such that the faces 3 comprise a series of trapezoidal grooves 3a spaced apart by trapezoidal tongues 3b in the form of cells 10. In particular, the trapezoidal tongues 3b comprise the cells 10 having an angled side facing outward. Each groove 3a may thereby be defined by one angled side, one short parallel side and one long parallel side of three different cells 10. In this manner, the grooves 3a are configured to receive a corresponding tongue 3b of an adjacent block 1 during assembly of a plurality of modular construction blocks 1. The faces 3 thereby form tongue and groove faces which are configured to interact with corresponding tongue and groove faces on a corresponding face 3 of an adjacent block 1 in an assembled modular construction.

The faces 3, 5 are thereby configured to form tongue and groove joints with adjacent blocks 1 along the x- and y-directions. The modular block 1 may thereby be stacked along each of the x-dimension (wall length) and the y-direction (wall depth) in order that a structure of desired dimensions can be built up in a modular manner.

In an embodiment not shown, a block 1 may comprise a corner piece in which a face 3, 5 may be configured to mate with a corresponding face of a further block 1 extending substantially perpendicularly thereto. For example, the tongue and groove arrangements of one of faces 3, 5 may be provided with tongues and grooves configured to interlock with tongues and grooves of the other of faces 3, 5 of the perpendicular block 1. Alternatively, the block 1 may itself comprise a right-angle, such that the block 1 itself forms a corner piece in isolation of a further block 1.

In a further embodiment not shown, a block 1 may comprise corner piece having a face extending at 45 degrees to the x-and y-directions. The 45-degree face may be configured to mate (e.g., via a tongue and groove arrangement) with a corresponding block 1 having a 45-degree face, such that the two blocks 1 having 45-degree faces together define a corner of a wall.

### Stackable in Z-Dimension

The block 1 comprises two faces 7 substantially perpendicular to the z-direction, of which only one face 7 is visible in FIG. 1. As shown in FIG. 1, the majority of the cells 10 terminate at the same location along the z-direction. A minority of cells 10 terminate at a different location along the z-direction, such that the minority of cells 10 are proud of the majority. In this manner, the face 7 comprises a number of protruding cells 7b which protrude substantially beyond the majority of the cells 10 in the z-direction.

In the example shown in FIG. 1, the protruding cells 7b are spaced apart from one another along the x-direction by three intervening cells 10. Similarly, the protruding cells 7b are spaced apart form one another along the y-direction by one intervening cell 10. In this manner, the protruding cells 7b have the same orientation; long parallel side facing towards the increasing y-direction.

It will be understood that the exact number of intervening cells 10 along the x- and y-directions between protruding cells 7b may be varied according to particular requirements. However, it may be desirable to maintain an odd-number of intervening cells 10 such that the protruding cells 7b maintain the same orientation.

On the face 7 not visible in FIG. 1, the block 1 comprises an array of trapezoidal prismatic recesses which corresponds in protruding dimension along the z-direction and the spacing of the protruding cells 7b of the visible face 7. For example, each cell 10, whether protruding or otherwise, may comprise the same dimension along the z-direction. Accordingly, the dimension by which the protruding cells 7b protrude may be equal to the depth of the corresponding recess on the opposing face 7.

It will be understood that, due to the uniform cross section and orientation of each cell 10, the protruding cells 7b and the corresponding recesses will comprise the same orientation. The lower face 7 not visible in FIG. 7 thereby comprises a corresponding array of recesses, each recess of which is configured to receive a protruding cell 7b of a corresponding face 7 of an adjacent block 1 in an assembled modular construction. The blocks 1 may thereby be stacked in the z-dimension (wall height) in order that a structure of desired height dimension can be built up in a modular manner.

The cells 10 may not comprise an end face perpendicular to the z-direction, such that a fluid, suspension or mixture (e.g., wet concrete) may be poured into each cell 10 along the z-direction.

Although shown aligned along the x-direction in FIG. 1, protruding cells 7b spaced apart along the y-direction need not necessarily be aligned along the x-direction. For example, no two protruding cells 7b may occupy the same location along the x-direction.

In this manner, the block 1 comprises protrusions 7b and recesses on opposing faces, the protrusions 7b being configured to engage the corresponding recesses of an adjacent block 1 along the z-direction in an assembled modular construction. In effect, adjacent blocks 1 interlock along the z-direction.

The modular block 1 thereby comprises a structure which is configured to cooperate with adjacent blocks 1 along each of the x-, y- and z-directions such that adjacent blocks may interlock and/or mate. Modular blocks 1 may thereby be stacked along one or more of the x-, y- and z-directions, such that a modular structure of any dimension may be constructed from a plurality of modular blocks 1 (e.g., a plurality of identical modular blocks 1).

Due to the interlocking arrangement between adjacent blocks 1, shine paths (e.g., straight lines through a structure along which radiation may potentially escape) between adjacent blocks 1 (e.g., in each of the three directions) may be eliminated when compared with prior blocks which do not comprise a cooperating or interlocking arrangement or do not comprise a cooperating arrangement to the same extent.

The skilled person will understand that, although shown with eight cells 10 in the y-dimension and four cells 10 in the x-dimension, the block 1 may comprise a greater number of cells 10 in one or more of the x- and y-dimensions, provided the tongue 3b, 5b and groove 3a, 5a arrangements are present on the external faces 3, 5.

By providing a block of modular construction, during the decommissioning phase, only those blocks which have received the greatest doses of radiation (e.g., only those cells which may have activated components) may be required to be removed.

### Framework

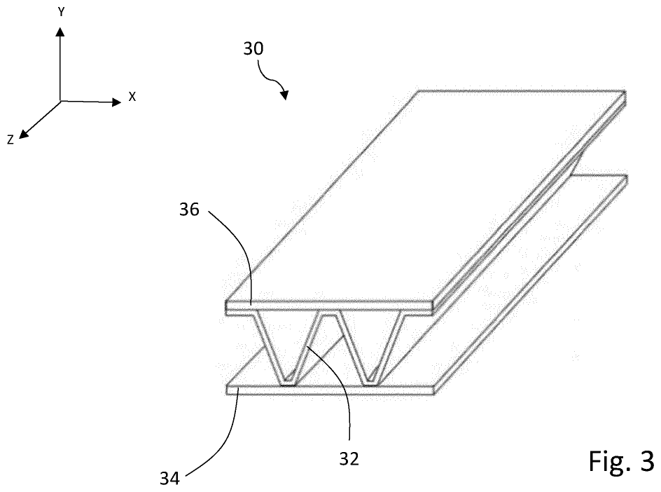

With reference to FIG. 3, an example structure of the framework 30 is described. The framework 30 comprises a corrugated sheet 32, comprising a repeating trapezoidal geometry in the x-y plane and a uniform cross section with distance along the z-direction.

The framework 30 further comprises a pair of sandwich panels 34, 36 which sandwich the corrugated sheet 32 therebetween. In particular, the sandwich panels 34, 36 substantially abut the short parallel sides of the repeating trapezoidal geometry of the corrugated sheet 32.

Each trapezoidal cell 10 is formed by the cooperation between the corrugated sheet 32 and a sandwich panel 34, 36. In particular, one of the sandwich panels 34, 36 forms a long parallel side of each cell 10 in a plane perpendicular to the y-direction. An adjacent cell along the x-direction may be formed by the cooperation between the corrugated sheet 32 and the other of the sandwich panels 34, 36.

It will be understood that each sandwich panel 32, 34 may form long parallel sides to cells 10 on either side, such that each panel 32, 34 may form a contiguous long parallel side to cells provided at 180 degrees to one another and adjacent along the y-direction.

In addition, or as an alternative, to the example of FIG. 3, a cell 10 may be formed by an individual trapezoidal prismatic cell which is separate and distinct from other framework cells, such that each individual cell 10 may be displaceable along the z-direction relative to other cells 10. For example, some rows (extending along the x-direction) of cells may be formed by the corrugated sheet 32 and sandwich panel 34, 36 arrangement of FIG. 3, whilst other rows (e.g., intervening rows) may be formed by individual trapezoidal cells. Alternatively, protruding cells 7b may be provided between the ends of adjacent corrugated sheets 32 as individual trapezoidal prismatic cells. The protruding cells 7b and corresponding recesses may be formed by displacing along the z-direction a proportion of the individual trapezoidal cells.

Whether formed by individual trapezoidal cells and/or the corrugated sheet 32 and sandwich panel 34, 36 arrangement of FIG. 3, the framework 30 comprises a basalt fibre reinforced polymer composite. The composite preferably comprises 30% by volume basalt fibre. The polymer may comprise epoxy. The fibre may be provided unidirectionally along the z-direction and having a uniform distribution. The composite may be formed by pultrusion along the Z-direction.

The present inventors have determined that the fire-resistant properties of basalt fibre are desirable as a construction material, particularly for nuclear bio-shields. The basalt fibre reinforced polymer composite may thereby replace steel reinforcing bars as a construction material. The skilled person will understand the advantages of a construction material comprising basalt fibre rather than steel when subjected to high temperatures.

Additionally, basalt fibre reinforced polymer composites have the advantage of not being activated when subjected to radiation (e.g., neutron and/or gamma radiation) during the course of the approximately 40-year lifespan of a bio-shield.

For scale, each block 1 may have a height of approximately 3 m.

### Concrete Filling

The trapezoidal prismatic internal volume 20 of each cell 10 of the framework 30 may be filled with concrete and allowed to solidify. Accordingly, the framework 30 acts as a reinforcing structure to the concrete. However, the nature of the reinforcement may differ from existing concrete reinforcing arrangements in that the cells 10 of the framework 30 may completely contain the reinforced concrete and divide the concrete into discrete volumes 20, rather than being an open mesh through which the concrete extends continuously.

The discrete nature of each volume 20 may permit the concrete within the block 1 to be graded. In particular, the properties of the concrete poured into each volume 20 may be varied depending on the location of a block 1 within a final structure. For example, in a bio-shield, concrete having greater density (e.g., borated concrete including boron-frits and/or baryte sand) with greater radiation absorption capabilities may be provided closer to a source of radiation in the final structure, and/or concrete having lower density (e.g., borated concrete including elemental boron, boric oxide and/or boron carbide) may be provided further from a source of radiation in the final structure.

Additionally or alternatively, the discrete nature of each volume 20 may permit certain cells 10 to not be filled with concrete. In this manner, scientific equipment (e.g., detectors, such as radiation detectors, or other monitoring devices) may be provided in otherwise empty cells 10 such that real-time data may be collected during service.

A proportion (e.g., none, some or all) of the cells 10 may comprise communication openings such that the internal volume of one cell 20 may communicate with the internal volume of an adjacent cell. During the concrete pouring procedure, the presence of communication openings may improve the filling of the block 1. Additionally or alternatively, data cables may pass through the openings between cells 10. This may facilitate the transmission of data from scientific equipment provided within otherwise empty cells 10.

The pouring of concrete into the block 1 may be performed off-site, such that the block 1 is delivered to a construction site already containing solidified concrete. This may have the advantage of a reduced construction time as separate blocks 1 will cool faster than an aggregate structure. Further, the application of vibration to concrete is easier for concrete being poured in smaller volumes, such that the presence of air pockets may be reduced (e.g., eliminated), thus improving the mechanical strength of the final structure.

The use of concrete in combination with basalt fibre reinforced polymer composite rather than steel as a reinforcing material may provide the advantage of thermal expansion coefficients which are closer in value.

### Curved Blocks

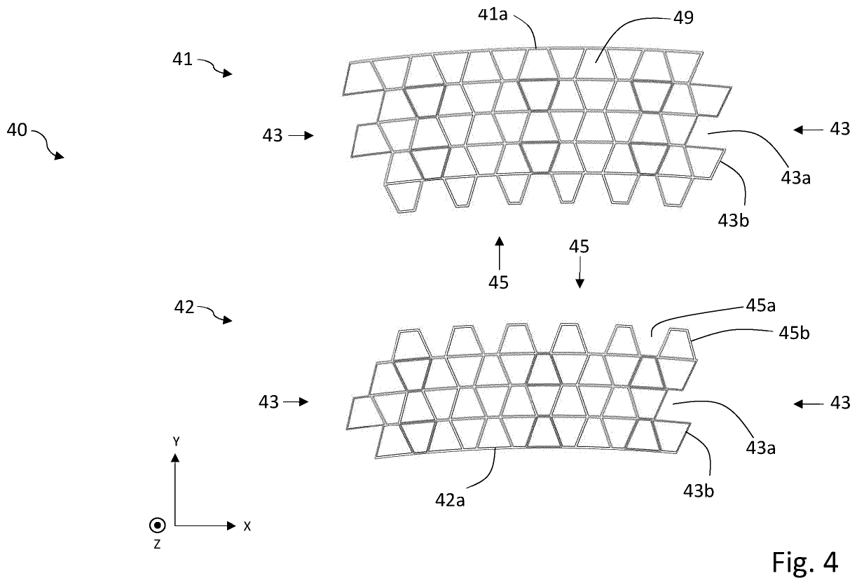

With reference to FIG. 4, a curved embodiment of the modular construction block is described. The modular construction blocks 41, 42 (collectively 40) are identical to the modular construction block 1 of the previous figures, with the following exceptions.

The block 40 comprises a curvature with a large radius relative to the scale of the block 40. The block 40 is configured to stack in the circumferential direction with other blocks in order to form a curved or complete, circular structure, e.g., a bio-shield wall intended to enclose a nuclear facility. The block 40 is configured to stack in the radial direction to increase a depth dimension of the structure. In the example shown in FIG. 4, each block 40 comprises an arc of 12° relative to a final structure and have a height of approximately 3 m.

Each of the short and long “parallel” sides of each substantially trapezoidal cell 49 comprises an arc. Accordingly, the “parallel” sides of each trapezoidal cell 49 are concentric arcs, with the centre being defined as the centre of the modular structure of which the blocks are intended to form modules. In exact terms, each substantially trapezoidal cell 49 comprises a sector minus a concentric sector of the same arc angle, but having a smaller radius. With radial distance away from the centre of each block 40, the length of the arcuate concentric sides of the cells 49 increases. Each substantially trapezoidal cell 49 further comprises two angled sides.

The two modular blocks 41, 42 shown in FIG. 4 represent innermost 42 and outermost 41 blocks of such a curved structure. Accordingly, the innermost block 42 comprises a continuous inner surface 42a, whilst the outermost block 41 comprises a continuous outer surface 41a. These continuous surfaces 41a, 42a may be achieved by providing a final sandwich panel 34, 36 on the innermost or outermost surface. Additionally or alternatively, the flat surfaces may be formed by providing a complete row of individual substantially trapezoidal cells 49, such that the short and long arcuate sides of the cells 49 alternate so as to form a continuous surface 41a, 42a. In other words, for the innermost surface 42a and the outermost surface 41a, the tongue and groove arrangement may be omitted. It will be understood by the skilled person that, for innermost and outermost blocks, the tongue and groove arrangement of the block 1 may also be omitted in the linear embodiment so as to provide a continuous outer surface.

The skilled person will understand from the foregoing that, in the same manner as the faces 3, 5 of the block 1, curved modular construction blocks 40 having tongue and groove features on each face extending in the z-direction (e.g., substantially facing the x/circumferential- and y/radial-directions) may be provided between the innermost and outermost blocks 40 and stacked in three dimensions in order to increase the overall dimensions of the structure. Further, the faces 7 perpendicular to the z-direction may also be provided on the block 40, such that the block 40 is stackable in the z-dimension.

Due to the considerations above, the skilled person will further understand that the modular blocks 1 may need to be bespoke (e.g., having predetermined locations and thus dimensions within a final modular structure) in order to achieve a structure of a particular inner radius and thickness. This may differ from the embodiment of the linear block 1, in which an identical block may be used throughout the structure (e.g., with the exception of the innermost, the outermost and possibly the end blocks).

### Method of Forming a Block

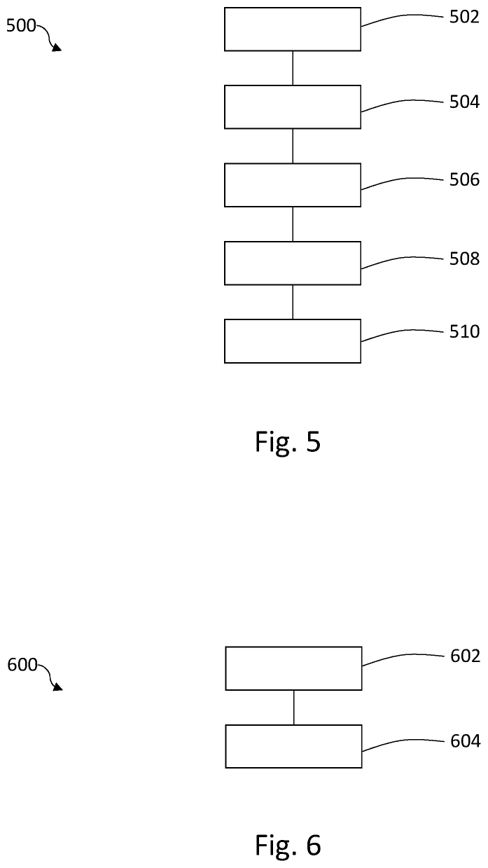

With reference to FIG. 5, a method 500 of forming a modular construction block 1, 40 is described. The method 500 comprises 502 forming a fibre framework (e.g., by pultrusion along the z-direction). The fibre framework may comprise the trapezoidal prismatic honeycomb-type structure described above in relation to FIGS. 1 to 4. The fibre may again comprise basalt fibre.

The method 500 comprises 504 impregnating the fibre framework with epoxy adhesive so as to form the fibre framework 30. The method 500 comprises 506 applying aggregates (e.g., sand) to the internal surfaces of the cells 10 (e.g., so as to adhere to the epoxy).

The method 500 comprises 508 curing the epoxy resin, and subsequently 510 pouring the concrete into the internal volumes 20. The concrete may then be permitted to harden.

Accordingly, in an installed configuration, the modular block 1, 40 may comprise basalt fibre and epoxy forming a basalt fibre reinforced polymer composite; concrete; and sand. The sand may form a mechanical interlocking between the composite and the concrete so as to improve the overall mechanical properties of the block 1, 40. From the method described above, it will be understood by the skilled person that the concrete does not impregnate the composite.

### Method of Forming a Structure

With reference to FIG. 6, a method 600 of forming a modular structure is described. The method 600 comprises stacking 602 a first block 1, 40 and a second block 1, 40 in the y/depth dimension. The method 600 further comprises stacking 604 a further block 1, 40 in the x-, y- and/or z-dimensions.

It will be appreciated by those skilled in the art that although the invention has been described by way of example, with reference to one or more examples, it is not limited to the disclosed examples and that alternative examples could be constructed without departing from the scope of the invention as defined by the appended claims.

1-15. (canceled)

16. A modular nuclear shield wall construction block comprising:
a framework formed from a fibre reinforced polymer composite; and
concrete interspersed within the framework,
wherein the block is configured to interlock with corresponding blocks in at least two of: the x or length dimension; the y or depth dimension; and the z or height dimension.

17. The block of claim 16, wherein the framework defines an array of cells each having an internal volume.

18. The block of claim 17, wherein each cell has a uniform cross section in the x-y plane at any location along the z-axis.

19. The block of claim 17, wherein the cells have a substantially trapezoidal cross section in the x-y plane.

20. The block of claim 17, wherein at least one pair of adjacent cells includes an opening configured to permit communication between the internal volumes of the at least one pair of adjacent cells.

21. The block of claim 16, wherein the block is configured to interlock with a corresponding block in the x or length dimension; the y or depth dimension; and the z or height dimension.

22. The block of claim 16, wherein the block is stackable in the x or length dimension and/or the y or depth dimension by means of a tongue and groove arrangement on faces of the block perpendicular to the x or length direction and/or the y or depth direction, respectively.

23. The block of claim 17, wherein a proportion of cells is offset along the z-axis such that they protrude from a face of the block being perpendicular to the z or height direction, and wherein the block includes a corresponding array of recesses on an opposing face such that the block is stackable along the z or height direction.

24. The block of claim 16, wherein the fibre reinforced polymer composite includes basalt fibre reinforced polymer composite.

25. The block of claim 16, wherein the block is linear or arcuate.

26. The block of claim 17, wherein concrete is provided in the internal volume of the cells.

27. The block of claim 26, wherein the concrete is graded between cells and/or wherein a proportion of cells do not include concrete.

28. A method of forming the block of claim 1, the method comprising the steps of:
(a) forming a fibre reinforced polymer composite framework; and
(b) pouring concrete into the framework.

29. A structure comprising a plurality of modular construction blocks according to claim 1.

30. A method of forming a modular structure, the method comprising stacking a first modular construction block according to claim 1 and a second modular construction block according to claim 1.

31. The block of claim 16, wherein the framework defines an array of cells, and wherein at least some of the cells are tessellated.
